(19) United States
(12) Patent Application Publication
(10) Pub. No.: US 2006/0203085 A1
(43) Pub. Date: Sep. 14, 2006

(54) There dimensional image signal producing circuit and three-dimensional image display apparatus

(76) Inventor: Seijiro Tomita, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/535,627

(22) PCT Filed: Nov. 28, 2002
(86) PCT No.: PCT/JP02/12443

§ 371 Date: Feb. 10, 2006

(51) Int. Cl. H04N 13/04; H04N 13/00; H04N 15/00

(52) U.S. Cl. 348/51; 348/42

(57) ABSTRACT

A three-dimensional display is provided which can produce a stereoscopic image with a natural stereoscopic depth even on different screen sizes. A stereoscopic video signal generation circuit, which supplies a stereoscopic video signal to the three-dimensional display that forms a stereoscopic image by taking advantage of binocular disparity parallax, comprises: an information retrieving means for retrieving video information on the stereoscopic image and display information on the three-dimensional display; and an offset setting means for offsetting a left-eye image and a right-eye image relative to each other according to the video information and the display information to adjust the stereoscopic depth of the image displayed.

### BACKGROUND OF THE INVENTION

1. Field of the Invention

The present invention relates to a display and more specifically to a stereoscopic video signal generation circuit capable of changing a depth of a stereoscopic image according to a display screen size. The invention also relates to a three-dimensional display incorporating the stereoscopic video signal generation circuit.

2. Description of the Prior Art

A conventional method of shooting a stereoscopic image of a subject, as described in Japanese Patent Disclosure No. 2001-231055, uses two cameras, a first camera for a right-eye image and a second camera for a left-eye image. An optical axis of the first camera and an optical axis of the second camera are made to cross each other at a crosspoint or convergence point CP on a subject plane. A technique has been proposed which measures a distance from the camera equipment to the subject plane (i.e., distance to the CP).

However, if the distance to the CP is measured while taking a stereoscopic picture of a subject, the distance to the CP (CP information) is not recorded at the same time that the stereoscopic image is recorded. Further, if the CP information is recorded, it is not utilized as a signal that forms a reference of three-dimensional effect when the stereoscopic image is reproduced.

When the same video content is reproduced on displays of different screen sizes in particular, a parallax between right- and left-eye images varies from one screen size to another, so that a stereoscopic depth (or a degree to which the image appears to pop out of the screen) changes according to the changing screen size, failing to produce a realistic stereoscopic view for all screen sizes. That is, because stereoscopic video contents for use in large-scale amusement facilities are produced to suite large screens on which they are to be displayed, they cannot be viewed with correct stereoscopic depths unless displayed on large screens of the intended size in theaters or on apparatus. When the screen size is too large, the stereoscopic sensation obtained is too strong causing dizziness or headache while too small a screen size fails to give the viewer a satisfactory three-dimensional effect.

The production of a stereoscopic video content involves adjusting a crosspoint of stereoscopic cameras and a parallax of computer-generated graphics according to the size of the screen that displays the video. If the video content is displayed on a three-dimensional display (3D display) of a screen size other than the intended one, a different three-dimensional effect is produced. Thus, the same video content needs to be produced again for different screen sizes. When a stereoscopic image is generated by computer graphics, rendering needs to be done from the scratch.

As described above, since no techniques have been available for adjusting the parallax used in the already produced video content as the video is being reproduced, there is no alternative but to adjust the three-dimensional effect by changing a distance between the viewer's position and the screen.

Further, in broadcasting a three-dimensional video, there has been no technique available for automatically adjusting the three-dimensional effect according to various screen sizes of 3D displays so that the 3D video can be seen by multiple viewers. It is therefore difficult to broadcast three-dimensional videos to unspecified multiple viewers. For a widespread use of three-dimensional videos a technique to adjust the three-dimensional effect according to the screen size is essential.

It is therefore an object of the present invention to provide a stereoscopic video signal generation circuit that can produce a 3D image with a natural stereoscopic depth even if the image is reproduced on a display of a different screen size. It is also an object of this invention to provide a 3D display using the stereoscopic video signal generation circuit.

### SUMMARY OF THE INVENTION

A first aspect of the present invention provides a stereoscopic video signal generation circuit for supplying a stereoscopic video signal to a three-dimensional display, wherein the three-dimensional display, displaying two images in the left eye and the right eye with binocular parallax and then selectively retrieving one of a left-eye image and a right-eye image in one of the left eye and the right eye and other in other of both eyes, forms a stereoscopic image to show an observer by taking advantage of binocular parallax, the stereoscopic video signal generation circuit comprising: an information retrieving means for retrieving as control information for controlling a display of each image video information including crosspoint (convergence point) information on a distance from a camera to a crosspoint of an optical axis of a left subject and an optical axis of a right subject when each of left image and right image is produced; and an offset setting means for offsetting a left-eye image and a right-eye image relative to each other according to the control information to adjust a stereoscopic depth of the image displayed.

In this invention, crosspoint is defined as a crosspoint (CP) where an optical axis of a left-eye camera and an optical axis of a right-eye camera are arranged slantly from positions for making collimated lines, so as to have the optical axis of the left-eye camera and the optical axis of the right-eye camera crossed.

A crosspoint information according to the invention also comprises: a distance information from a camera to a crosspoint of an optical axis of a left screen and an optical axis of a right screen which make a left-eye image and a right-eye image respectively according to the first aspect of the invention; and a crosspoint information on a distance between a left-eye camera and a right-eye camera (binocular distance) according to the third aspect of the invention.

A second aspect of the present invention provides a stereoscopic video signal generation circuit according to the first aspect, wherein the above information retrieving means retrieves as the video information at least one of applicable screen size information as the video information on a screen size suited for reproducing the stereoscopic image, applicable viewing distance information as the display information on a distance from an observer to a screen suited for the observer to see the image as it is reproduced, and display information involving viewing distance information on a distance from the observer to the screen of the three-dimensional display, wherein the offset setting means offsets the left-eye image and the right-eye image relative to each other according to one or more of the optimal screen size information and the applicable viewing distance information to reproduce the stereoscopic depth of the image displayed.

A third aspect of the present invention provides a stereoscopic video signal generation circuit according to one of the first and second aspects, wherein the information retrieving means retrieves as the video information information on a distance between an optical axis of a left-eye camera and an optical axis of a right-eye camera, wherein the offset setting means offsets the left-eye image and the right-eye image relative to each other according to the camera distance information and the crosspoint (convergence point) information to adjust the stereoscopic depth of the image displayed. In this case, a shooting apparatus comprising a left-eye camera and a right-eye camera is equipped with a crosspoint data input unit in which a distance from the camera to the CP during stereoscopic image shooting is measured by a laser measurement or from a slant degree between the left-eye camera and the right-eye camera and the shooter feeds into. Additionally, the distance between the left-eye camera and the right-eye camera (binocular distance) is recorded as a CP information.

According to the invention, a stereoscopic image can be obtained which is adjusted to the optimal depth of a stereoscopic image according to the screen size of the stereoscopic display by the distance between cameras set relative to the stereoscopic image.

A fourth aspect of the present invention provides a stereoscopic video signal generation circuit according to any one of the first to third aspects, wherein the information input means retrieves information entered about the stereoscopic depth and the offset setting means offsets the left-eye image and the right-eye image relative to each other according to the information entered into the input means to adjust the stereoscopic depth of the image displayed.

A fifth aspect of the present invention provides a stereoscopic video signal generation circuit according to any one of the first to fourth aspects, further comprising: a left-eye image frame memory for storing the left-eye image and a right-eye image frame memory for storing the right-eye image; wherein the offset setting means has a timing control means for controlling a timing of reading video data from the left-eye image frame memory and/or the right-eye image frame memory, and the timing control means advances or delays the timing of reading the video data from one of the left-eye image frame memory and the right-eye image frame memory with respect to the timing of reading the video data from the other frame memory to offset the left-eye image and the right-eye image relative to each other.

A sixth aspect of the present invention provides a stereoscopic video signal generation circuit according to the fifth aspect, further comprising: a stereoscopic image frame memory for storing the stereoscopic image; and a signal selection means for selecting between video data read out from the left-eye image frame memory and video data read out from the right-eye image frame memory and feeding the selected data into the stereoscopic image frame memory.

A seventh aspect of the present invention provides a stereoscopic video signal generation circuit according to any one of the first to fourth aspects, wherein the left-eye image and the right-eye image are offset relative to each other by advancing or delaying a horizontal phase between the left-eye image and the right-eye image.

An eighth aspect of the present invention provides a stereoscopic video signal generation circuit according to any one of the first to seventh aspects, wherein, when the left-eye image and the right-eye image are offset, in left and/or right end blanked-out areas of the screen where information of the left-eye image and/or the right-eye image is not displayed, left or right edge portion of the left-eye image and/or the right-eye image near the blanked-out areas is displayed magnified horizontally and vertically.

A ninth aspect of the present invention provides a three-dimensional display which displays two images of a left image and a right image formed with binocular parallax and selectively retrieves one of the two images in one of the left eye and the right eye and other in other of both eyes for forming a stereoscopic image to show an observer by taking advantage of parallax, the three-dimensional display comprising: a stereoscopic video signal generation circuit for combining a left-eye image and a right-eye image to generate a stereoscopic video signal, a display for displaying the stereoscopic image and a driver circuit for driving the display; wherein the stereoscopic video signal generation circuit has an information retrieving means for retrieving as control information for controlling a display of each image video information including crosspoint (convergence point) information on a distance from a camera to a crosspoint of an optical axis of the left subject and an optical axis of the right subject when each of left image and right image is produced, and an offset setting means for offsetting the left-eye image and the right-eye image relative to each other according to the control information to adjust a stereoscopic depth of the image displayed on the display; wherein the driver circuit forms the stereoscopic image on the display according to the stereoscopic video signal output from the stereoscopic video signal generation circuit.

A tenth aspect of the present invention provides a three-dimensional display according to the ninth aspect, further comprising: a memory means for storing as the video information at least one of applicable screen size information as video information suited for reproducing the stereoscopic image, applicable viewing distance information on a distance from an observer to a screen suited for the observer to see the image as it is reproduced, and display information involving the applicable viewing distance information relative to the screen of the three-dimensional display, wherein the offset setting means offsets the left-eye image and the right-eye image relative to each other according to the information which the memory means stores for reproducing the stereoscopic depth of the image displayed.

An eleventh aspect of the present invention provides a three-dimensional display according to one of the ninth and tenth aspects, wherein the information retrieving means retrieves as the video information distance information on a distance between an optical axis of a left-eye camera and an optical axis of a right-eye camera; and the offset setting means offsets the left-eye image and the right-eye image relative to each other according to the camera distance information and the crosspoint (convergence point) information to adjust the stereoscopic depth of the image displayed.

A twelfth aspect of the present invention provides a three-dimensional display according to one of the ninth to eleventh aspects, further comprising: an input means for the observer to input information on the stereoscopic depth; wherein the offset setting means offsets the left-eye image and the right-eye image relative to each other according to the information entered into the input means to adjust the stereoscopic depth of the image displayed on the display.

A thirteenth aspect of the present invention provides a three-dimensional display according to any one of the ninth to twelfth aspects, further comprising: a left-eye image frame memory for storing the left-eye image and a right-eye image frame memory for storing the right-eye image; wherein the offset setting means has a timing control means for controlling a timing of reading video data from the left-eye image frame memory and/or the right-eye image frame memory, and the timing control means advances or delays the timing of reading the video data from one of the left-eye image frame memory and the right-eye image frame memory with respect to the timing of reading the video data from the other frame memory to offset the left-eye image and the right-eye image relative to each other.

A fourteenth aspect of the present invention provides a three-dimensional display according to any one of the ninth to thirteenth aspects, further comprising: a stereoscopic image frame memory for storing the stereoscopic image; and a signal selection means for selecting between left-eye image data read out from the left-eye image frame memory and right-eye image data read out from the right-eye image frame memory and feeding the selected data into the stereoscopic image frame memory.

A fifteenth aspect of the present invention provides a three-dimensional display according to any one of the ninth to fourteenth aspects, wherein the left-eye image and the right-eye image are offset relative to each other by advancing or delaying a horizontal phase between the left-eye image and the right-eye image.

According to the invention, the arrangement allows the left-eye image and the right-eye image to be displayed at a different timing to control easily the offsetting of the left-eye image and the right-eye image.

A sixteenth aspect of the present invention provides a three-dimensional display according to any one of the ninth to fifteenth aspects, wherein, when the left-eye image and the right-eye image are offset, in left and/or right end blanked-out areas of the screen where information of the left-eye image and/or the right-eye image is not displayed, left or right edge portion of the left-eye image and/or the right-eye image near the blanked-out portions is displayed magnified horizontally and vertically.

### BRIEF DESCRIPTION OF THE DRAWINGS

FIG. 1 is a block diagram showing a stereoscopic video signal generation circuit according to one embodiment of this invention.

FIG. 2 is an explanatory diagram showing how a stereoscopic image is changed by a stereoscopic depth adjustment.

FIG. 3 is an explanatory diagram showing how a stereoscopic image is changed by a stereoscopic depth adjustment.

FIG. 4 is an explanatory diagram showing how a stereoscopic image is changed by a stereoscopic depth adjustment.

FIG. 5 is a schematic diagram showing a configuration of a 3D display using the stereoscopic video signal generation circuit according to one embodiment of this invention.

FIG. 6 is a schematic diagram showing a relation between a left-eye image and a right-eye image in the embodiment of FIG. 5.

FIG. 7 is a schematic diagram showing a configuration of a 3D display using the stereoscopic video signal generation circuit according to another embodiment of this invention.

FIG. 8 is a schematic diagram showing a configuration of a 3D display using the stereoscopic video signal generation circuit according to still another embodiment of this invention.

FIG. 9 is a schematic diagram showing a configuration of a 3D display using the stereoscopic video signal generation circuit according to yet another embodiment of this invention.

FIG. 10 is a schematic diagram showing a relation between a left-eye image and a right-eye image in the embodiments of FIG. 7 and FIG. 8.

FIG. 11 is a schematic diagram showing a configuration of a 3D display using the stereoscopic video signal generation circuit according to a further embodiment of this invention.

FIG. 12 is a schematic diagram showing a relation between a left-eye image and a right-eye image in the embodiment of FIG. 11.

FIG. 13 is an explanatory diagram showing how a stereoscopic image is seen in the preceding embodiments of this invention.

FIG. 14 is an explanatory diagram showing how a stereoscopic image is seen in the preceding embodiments of this invention.

FIG. 15 is an explanatory diagram showing how a stereoscopic image is seen in the preceding embodiments of this invention.

FIG. 16 is an explanatory diagram showing how a stereoscopic image is seen in the preceding embodiments of this invention.

FIG. 17 is an explanatory diagram showing how a stereoscopic image is seen in the preceding embodiments of this invention.

### DETAILED DESCRIPTION OF THE PREFERRED EMBODIMENTS

Embodiments of the present invention will be described by referring to the accompanying drawings.

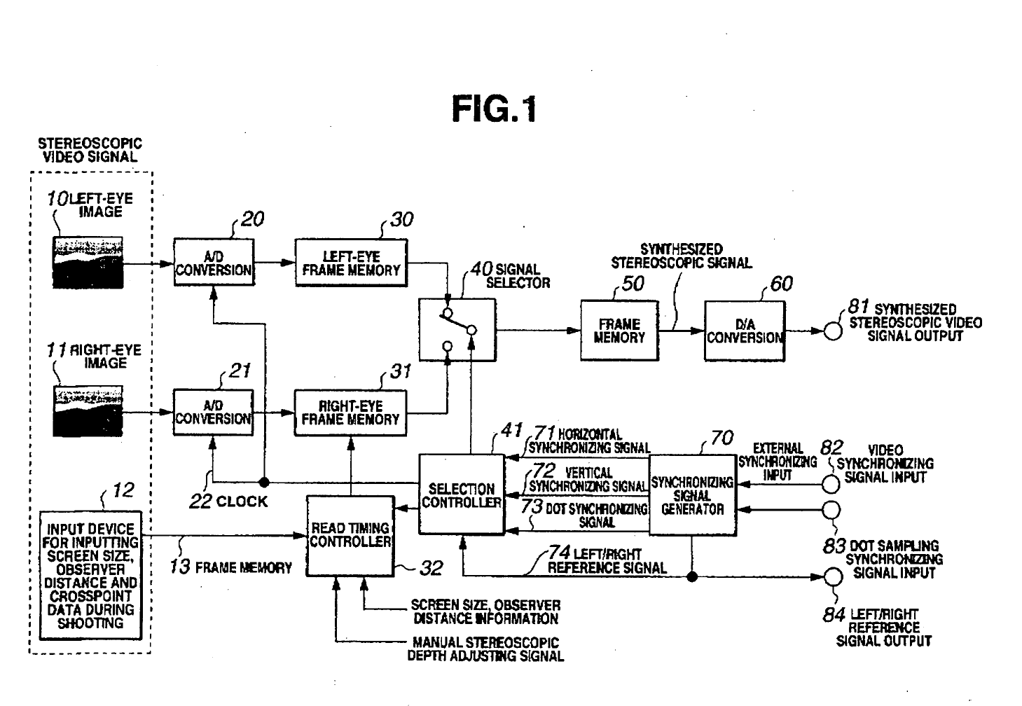

FIG. 1 is a block diagram showing the configuration of a stereoscopic video signal generation circuit according to one embodiment of this invention.

The stereoscopic video signal generation circuit according to one embodiment of this invention receives, as data recorded during shooting, a left-eye image 10, a right-eye image 11, and a distance to crosspoint (CP information) 13. The left-eye image 10 is shot by a left-eye camera and the right-eye image 11 by a right-eye camera arranged side by side with the left-eye camera. The left-eye camera and the right-eye camera are inclined toward each other, i.e., they are shifted from their parallel positions where their optical axes are parallel, so that their optical axes cross each other. A point where the cameras' optical axes cross is a crosspoint (CP) located on an object plane. During shooting, the camera equipment measures a distance to the CP through laser ranging or from inclination between the left- and right-eye cameras. The camera equipment also has a crosspoint data input device 12 into which a camera operator enters data. With these provisions the camera equipment records the distance to CP as the CP information along with a stereoscopic video during shooting. A distance between the left- and right-eye cameras (interocular distance) is also recorded as the CP information. The interocular distance information corresponds to a distance between human eyes and is selected from a range of between 63 mm and 68 mm.

The left-eye image 10 entered into the stereoscopic video signal generation circuit is digitized by an A/D converter 20 and recorded in a left-eye image frame memory 30. Similarly, the right-eye image 11 entered into the circuit is digitized by an A/D converter 21 and recorded in a right-eye image frame memory 31. The A/D converters 20, 21 receive a clock signal 22 from a selection controller 41 for A/D conversion.

The left-eye image and the right-eye image, which were digitized and stored in the frame memories 30, 31, are input to a signal selector 40. The signal selector 40 selects between the left- and right-eye images to store a synthesized stereoscopic image in a synthesized frame memory 50 to generate a synthesized video signal. The signal selector 40 is a switch (semiconductor switching device) that is driven by a timing signal from the selection controller 41. The stereoscopic video signal generation circuit of this embodiment combines the left-eye image 10 and the right-eye image 11 to form a synthesized stereoscopic video signal for each horizontal line. That is, in an interlace system, since an image is displayed on every other scan line, the signal selector 40 selects a video signal to be written into the synthesized frame memory 50 for each field (e.g., every 16.6833 ms or vertical synchronizing timing of the NTSC system). In a non-interlace system on the other hand, since all scan lines are displayed successively, the signal selector 40 selects a video signal to be written into the synthesized frame memory 50 for each scan line (e.g., every 63.5555 μs or horizontal synchronizing timing of the NTSC system) to display the left-eye image and the right-eye image on alternate scan lines.

The timing at which to read the right-eye image data from the right-eye image frame memory 31 for writing into the synthesized frame memory 50 is controlled by a read timing controller 32. The read timing controller 32 receives the CP information 13, a timing signal for the signal selector 40 from the selection controller 41, screen size information and a depth adjust signal. The read timing controller 32 calculates from these information a timing at which to read from the right-eye image frame memory 31 and generates a clock that triggers the reading of data from the right-eye image frame memory 31 at a timing lagging (or leading) the normal timing, thereby adjusting the read timing to provide a parallax that produces an appropriate three-dimensional effect. That is, the timing at which to read the right-eye signal from the right-eye image frame memory 31 with respect to the left-eye signal read timing is controlled based on the CP information 13 and the screen size information to ensure that the right-eye signal is read out at a timing that produces an optimum three-dimensional effect.

The selection controller 41 controls the operation of the signal selector 40 according to a horizontal synchronizing signal 71, a vertical synchronizing signal 72, a dot synchronizing signal 73 and a left/right reference signal 74, all supplied from a synchronizing signal generator 70. That is, as described above, the selection controller 41 sets a timing at which the signal selector 40 is switched to write video data into the synthesized frame memory 50 to generate a synthesized stereoscopic video signal.

The synchronizing signal generator 70 generates the horizontal synchronizing signal 71 and the vertical synchronizing signal 72 according to a video synchronizing signal 82 supplied from the outside of the stereoscopic video signal generation circuit (e.g., from a display controller). It also generates the dot synchronizing signal 73 according to a dot sampling signal 83 supplied from an external circuit. It also generates the left/right reference signal 74 based on the video synchronizing signal 82. The left/right reference signal 74 is a signal for determining whether the video signal is for the left-eye image or the right-eye image when a stereoscopic video is displayed and transmitted by using a general video signal. The left/right reference signal 74 is supplied to the selection controller 41 and also output to the outside of the stereoscopic video signal generation circuit.

A D/A converter 60 converts a digital video signal into an analog signal and outputs it as a synthesized stereoscopic video signal.

In the embodiment described above, the timing for reading the right-eye image data is controlled according to the CP information 13 and the screen size information to produce an appropriate three-dimensional effect. Also in a case where the distance to CP is infinite (no CP information 13 is available), it is possible to control the right-eye image data read timing according to the screen size information to adjust the parallax.

When a 3D camera equipment with a pair of left- and right-eye cameras (each consisting of a lens and an imaging device) is used, a distance between the left- and right-eye cameras (interocular distance) and a distance to a crosspoint of optical axes of the left- and right-eye cameras are recorded as crosspoint information at the same time that the left- and right-eye images are supplied to and recorded in the stereoscopic video signal generation circuit. That is, the 3D camera equipment records the data on three-dimensional effect as well as the stereoscopic video data.

When a 3D video generation equipment with a function to generate a pair of left- and right-eye images with computer graphics (CG) is used, a distance between left and right eyes and a distance to an optical crosspoint of the left- and right-eye images (where left- and right-eye sight lines cross each other) are generated as crosspoint information at the same time that the left- and right-eye images are supplied to and recorded in the stereoscopic video signal generation circuit. That is, the 3D video generation equipment generates and records data on three-dimensional effect as well as CG images.

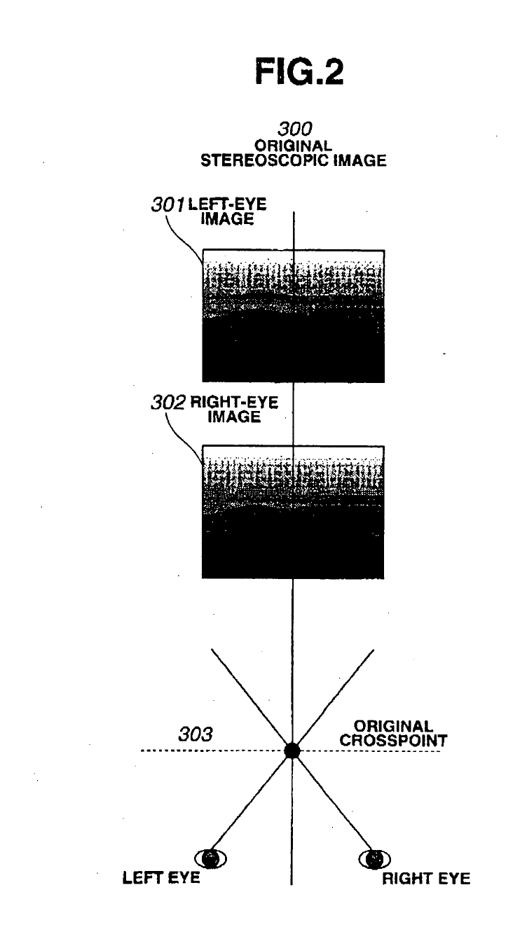

FIG. 2 through FIG. 4 are explanatory views showing how the stereoscopic depth is adjusted as the relative positions of the left- and right-eye images change in this embodiment of the invention.

FIG. 2 shows right- and left-eye images located at the same positions as when they were shot. An original 3D image 300 consists of a left-eye image 301 and a right-eye image 302. In this state, the left-eye image 301 and the right-eye image 302 are located at the same positions as when they were shot and the relative positions of the left- and right-eye images are correctly reconstructed. Hence, a crosspoint 303 is located at a position of an original crosspoint (the same position as when the shooting was made).

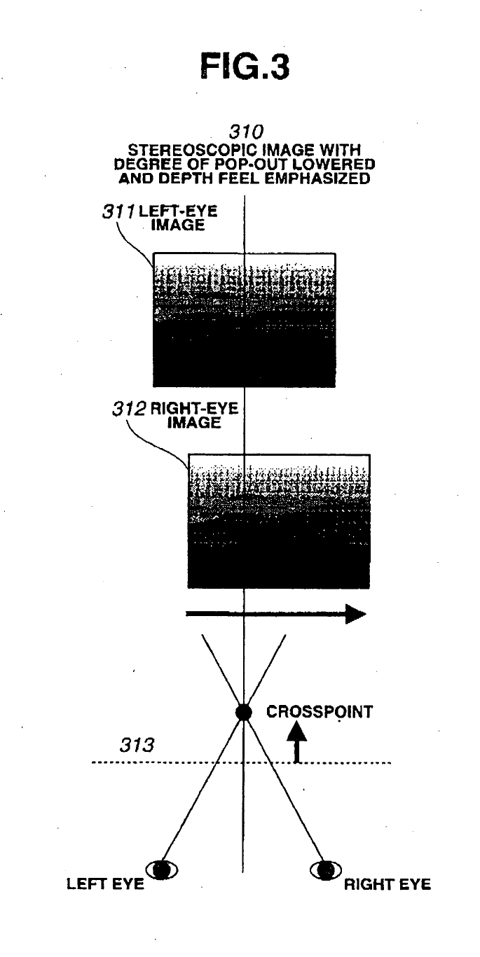

FIG. 3 shows the right-eye image shifted toward the right. A 3D image 310 consists of a left-eye image 311 and a right-eye image 312. When the right-eye image is displayed offset to the right by delaying the timing of reading the right-eye image with respect to the timing of reading the left-eye image (i.e., delaying the phase of the right-eye signal) to shift the right-eye image toward the right relative to the left-eye image, a left-eye sight line to the left-eye image and a right-eye sight line to the right-eye image cross each other at a point behind the display screen, i.e., the crosspoint moves rearwardly to a point 313 from the position where it was when the original 3D image was shot. As a result, a sensation of the image popping out forward is mitigated and instead a receding sensation is emphasized, making the entire image look as if it moved rearward.

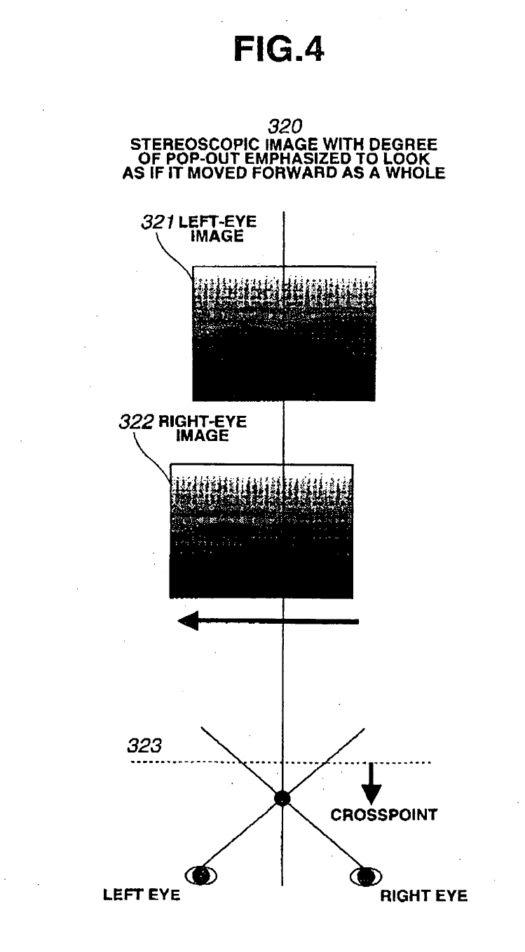

FIG. 4 shows the right-eye image shifted toward the left. A 3D image 320 consists of a left-eye image 321 and a right-eye image 322. When the right-eye image is displayed offset to the left by advancing the timing of reading the right-eye image with respect to the timing of reading the left-eye image (i.e., advancing the phase of the right-eye signal) to shift the right-eye image toward the left relative to the left-eye image, a left-eye sight line to the left-eye image and a right-eye sight line to the right-eye image cross each other at a point in front of the display screen, i.e., the crosspoint moves forwardly to a point 323 from the position where it was when the original 3D image was shot. As a result, a sensation of the image popping out forward is emphasized and instead a receding sensation is mitigated, making the entire image look as if it moved forward.

When the left-eye image and the right-eye image are displayed with the above-described offset setting, an end portion of the screen to the right or left of either the left-eye image or right-eye image is blanked out. In that case, an end portion of the offset image adjacent to the blanked-out area need only be magnified horizontally to fill the blank area. At this time, the end portion is also magnified vertically according to an aspect ratio of the screen. More specifically, in the offset condition shown in FIG. 3, there is a blank portion on the screen to the left of the right-eye image and thus the left end portion of the right-eye image is extended to the left end of the screen. In the offset condition of FIG. 4, there is a blank portion on the screen to the right of the right-eye image and thus the right end portion of the right-eye image is extended to the right end of the screen. Magnifying the side portion of the offset image by extending it horizontally and also vertically according to the aspect ratio of the screen can prevent a blank area (a black area where nothing is displayed) from appearing at the end of the screen to one side of the offset image and thereby display a natural stereoscopic image.

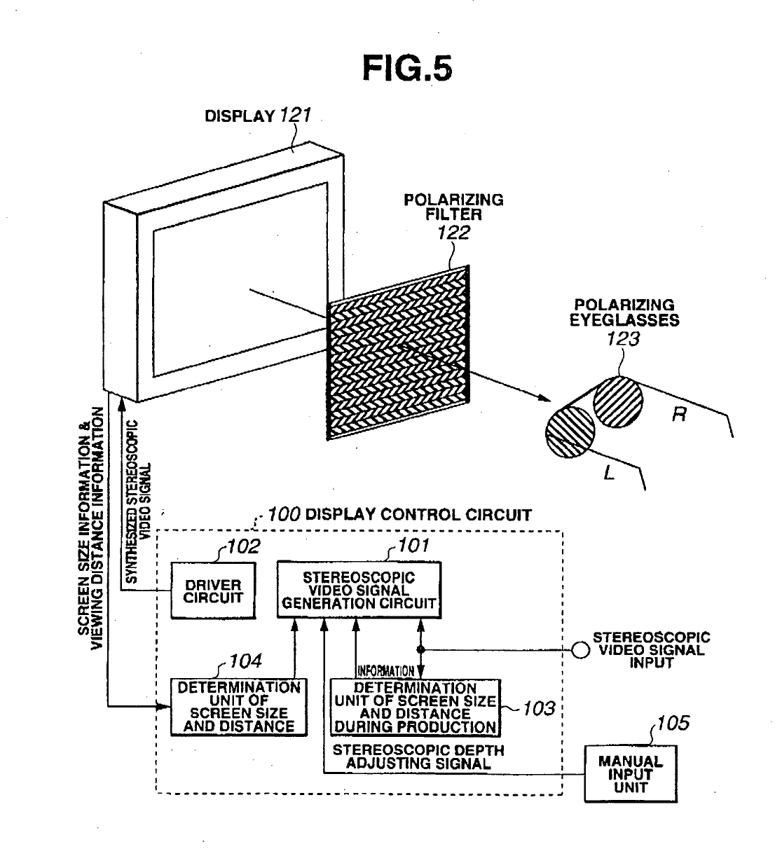

FIG. 5 is a schematic diagram showing a configuration of a 3D display using the stereoscopic video signal generation circuit according to one embodiment of this invention.

A display 121 is formed by a plasma display panel that displays a left-eye image and a right-eye image on alternate horizontal pixel lines. In front of the plasma display panel is disposed a polarizing filter 122 which consists of polarizing filter strips arranged at a pitch corresponding to the horizontal pixel line pitch.

The polarizing filter 122 has a first region that passes first rays of light with a particular polarization and a second region that passes second rays of light whose polarization axis is perpendicular to that of the first region, the first and second regions being arranged to face the corresponding horizontal pixel lines on the plasma display panel. That is, the polarizing filter 122 has the two regions, each of which transmits differently polarized light, alternated for every horizontal pixel line of the plasma display panel. Therefore, the left-eye image and the right-eye image that are displayed on alternate lines of the plasma display panel are separated into differently polarized rays of light that are emitted to a viewer. In this way, a left-eye image display region and a right-eye image display region are formed alternately on every other horizontal line of the display 121.

The viewer sees through polarizing eyeglasses 123 a stereoscopic image shown on the display 121. The left- and right-eye lenses of the polarizing eyeglasses 123 have the same polarizations as those of the first and second regions of the polarizing filter 122. That is, the left-eye lens of the polarizing eyeglasses 123 transmits light that has passed through the first region of the polarizing filter 122 and the right-eye lens transmits light that has passed through the second region of the polarizing filter 122. Thus, the left-eye image displayed on the display 121 passes through the left-eye lens of the polarizing eyeglasses 123 and reaches the left eye of the viewer while the right-eye image passes through the right-eye lens of the polarizing eyeglasses 123 and reaches the right eye.

A display control circuit 100 comprises a stereoscopic video signal generation circuit 101, a driver circuit 102, an in-production screen size & distance decision unit 103 and a screen size & distance decision unit 104.

The stereoscopic video signal generation circuit 101, as described above, generates a synthesized stereoscopic video signal from the received stereoscopic video signals and supplies the synthesized stereoscopic video signal through the driver circuit 102 to the display 121. The display 121 outputs screen size information representing a size of a displayable area of a display device installed in the display 121. This screen size information is set for each display and indicates the numbers of vertical and horizontal dots and the display area size, both stored in a memory in the display. Further, the display 121 outputs view distance information representing a distance at which an observer is to see an image on the display 121. The view distance information may be determined based on the size of the display area or by measuring a distance from the display 121 to the observer using an observer detection device mounted on the display 121.

The screen size information and the view distance information output from the display 121 are supplied to the screen size & distance decision unit 104 where they are converted into data compatible in format with the stereoscopic video signal generation circuit 101 before being fed to the stereoscopic video signal generation circuit 101.

The in-production screen size & distance decision unit 103, based on the stereoscopic video signals supplied to the display control circuit 100, extracts applicable screen size information representing screen sizes suited for reproducing a stereoscopic image, applicable view distance information representing a suitable distance to the screen for an observer to see an image being reproduced on the screen, a camera distance information representing a distance between an optical axis of a left-eye camera and an optical axis of a right-eye camera, and a crosspoint information representing a distance to a crosspoint of the left-eye camera's optical axis and the right-eye camera's optical axis, and then converts these information into data compatible in format with the stereoscopic video signal generation circuit 101 before being supplied to the stereoscopic video signal generation circuit 101.

The stereoscopic video signal generation circuit 101 is supplied with a depth adjust signal from an input unit 105 and, according to a stereoscopic depth specified on the input unit 105 by the observer, can offset the left- and right-eye images to change the stereoscopic depth of a 3D image formed on the display 121.

The input unit 105 includes switches and variable resistors operated by an observer and can change an operation condition of the display control circuit according to the observer's setting. The input unit 105 supplies a screen size switching signal to the screen size & distance decision unit 104. The input unit 105 also outputs the depth adjust signal to the stereoscopic video signal generation circuit 101 which in turn adjusts the parallax to produce an optimum three-dimensional effect for the observer.

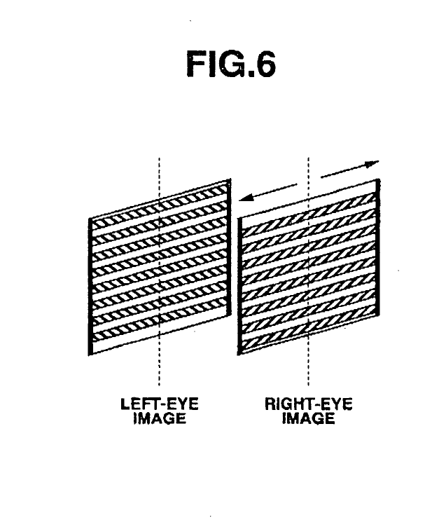

FIG. 6 is a diagram showing a relation between a left-eye image and a right-eye image shown on the display 121.

The left-eye image reaching the left eye of the observer and the right-eye image reaching the right eye are displayed on alternate horizontal lines of the display 121. The stereoscopic video signal generation circuit 101 performs control to delay or advance the timing for reading the right-eye image from the right-eye image frame memory 31 to delay or advance a horizontal phase of the right-eye image with respect to the left-eye image and thereby change an offset of the right-eye image relative to the left-eye image to adjust a binocular parallax and therefore a stereoscopic depth.

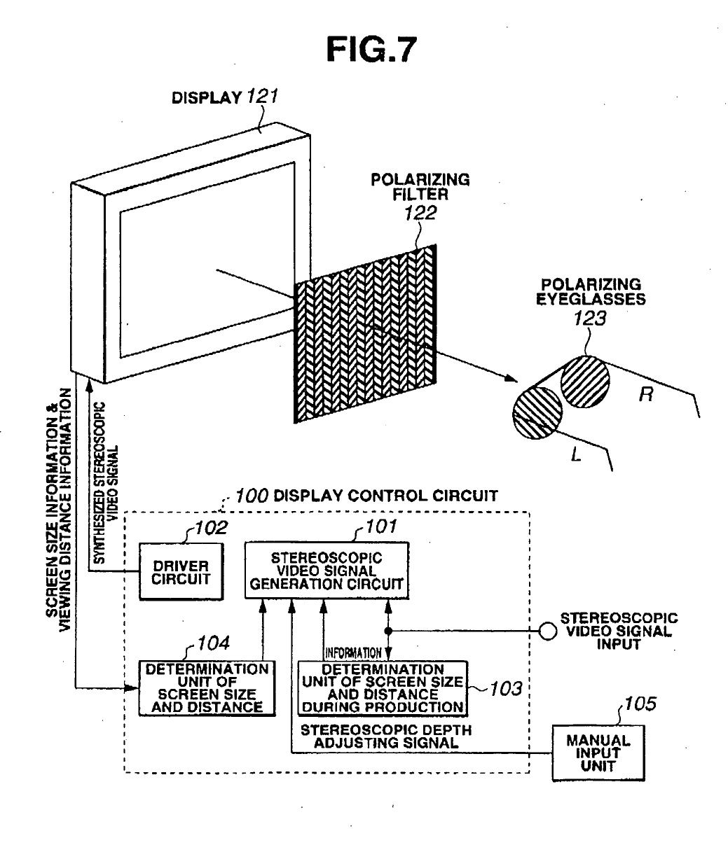

FIG. 7 is a schematic diagram showing a configuration of another 3D display using the stereoscopic video signal generation circuit according to another embodiment of the present invention.

A display 121 is formed by a plasma display panel that displays a left-eye image and a right-eye image on alternate pixels in each horizontal line. That is, on the plasma display an image for the same eye (left-eye image or right-eye image) is aligned in the vertical direction. In front of the plasma display panel is disposed a polarizing filter 122 which consists of vertical polarizing filter strips arranged at a pitch corresponding to that of pixels in horizontal lines.

The polarizing filter 122 has a first region that passes first rays of light with a particular polarization and a second region that passes second rays of light whose polarization axis is perpendicular to that of the first region, the first and second regions being arranged on positions corresponding to the pixels on the plasma display panel. That is, the polarizing filter 122 has the two regions, each of which transmits differently polarized light, alternated for every pixel of the plasma display panel in the horizontal direction so that the same region is continuously aligned vertically. Therefore, the left-eye image and the right-eye image that are displayed on alternate pixels of the plasma display panel are separated into differently polarized rays of light that are radiated to an observer. In this way, a left-eye image display region and a right-eye image display region are formed alternately on every other pixel of the display 121, with each region continuously extending vertically.

The observer sees through the polarizing eyeglasses 123 a 3D image displayed on the display 121. The left- and right-eye lenses of the polarizing glasses have the same polarizations as those of the first and second regions of the polarizing filter 122. That is, the left-eye lens of the polarizing eyeglasses 123 transmits light that has passed through the first region of the polarizing filter 122 and the right-eye lens transmits light that has passed through the second region of the polarizing filter 122. Thus, the left-eye image displayed on the display 121 passes through the left-eye lens of the polarizing eyeglasses 123 and reaches the left eye of the observer while the right-eye image passes through the right-eye lens of the polarizing eyeglasses 123 and reaches the right eye.

A display control circuit 100 comprises a stereoscopic video signal generation circuit 101, a driver circuit 102, an in-production screen size & distance decision unit 103 and a screen size & distance decision unit 104. These circuits have the same functions as those in the previous embodiment (FIG. 5) and their detailed descriptions are omitted.

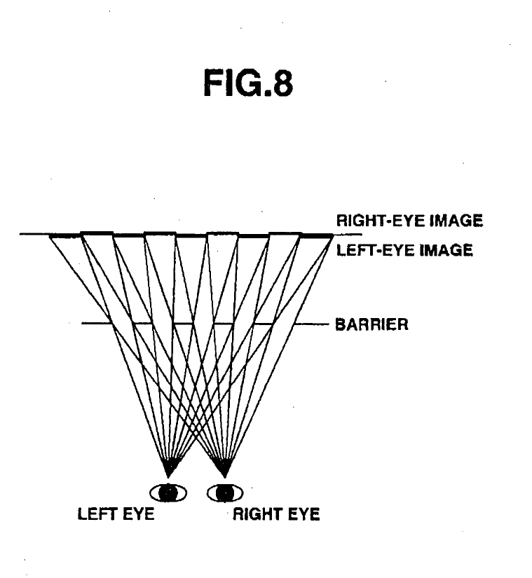

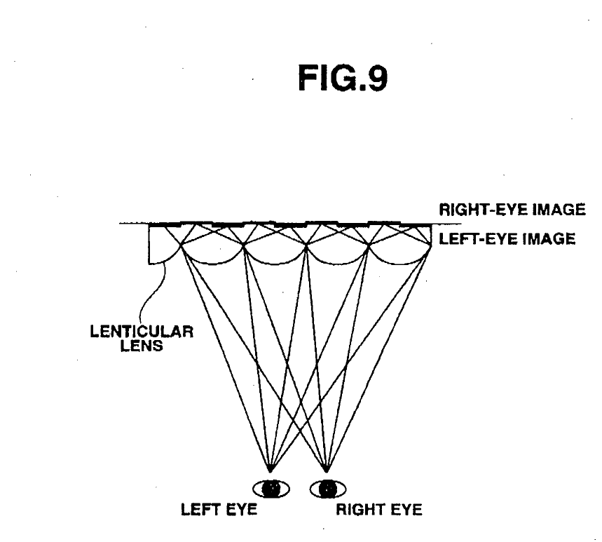

FIG. 8 and FIG. 9 show other configurations of the 3D display (shown in FIG. 7) in which an image for the same eye (left-eye image or right-eye image) is aligned vertically (or extends vertically continuously).

The 3D display shown in FIG. 8 is of a parallax barrier type in which a blind-like parallax barrier is disposed in front of the screen (plasma display panel). For an observer located at a predetermined position relative to the screen, the parallax barrier works as a barrier between the left eye of the observer and the right-eye image so that the right-eye image reaches only the right eye of the observer. The parallax barrier also works as a barrier between the right eye and the left-eye image so that the left-eye image reaches only the left eye. That is, the left eye cannot see the right-eye image and can only see the left-eye image. Likewise, the right eye cannot see the left-eye image and can only see the right-eye image.

FIG. 9 shows a 3D display of a lenticular type in which vertically elongate, semicylindrical lenticular lenses are provided in front of the screen (plasma display panel). For an observer located at a predetermined position relative to the screen, the lenticular lenses ensure that only the left-eye image reaches the left eye of the observer and that only the right-eye image reaches the right eye. That is, the left eye cannot see the right-eye image and can only see the left-eye image. Likewise, the right eye cannot see the left-eye image and can only see the right-eye image.

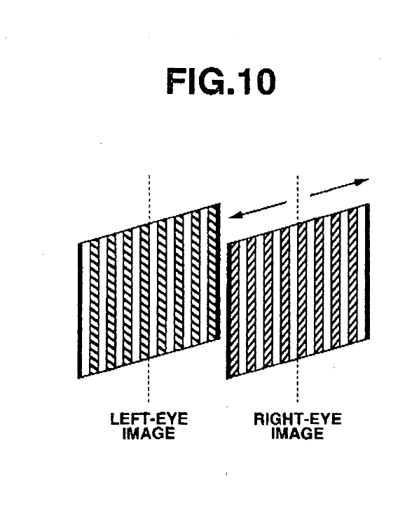

FIG. 10 shows a relation between the left-eye image and the right-eye image formed on the display 121.

The left-eye image that reaches the left eye of the observer and the right-eye image that reaches the right eye are displayed on alternate pixels arranged on each horizontal line of the display 121. The stereoscopic video signal generation circuit 101 performs control to delay or advance the timing of reading the right-eye image from the right-eye image frame memory 31 to delay or advance a horizontal phase of the right-eye image with respect to the left-eye image and thereby change an offset of the right-eye image relative to the left-eye image to adjust a binocular parallax and therefore a stereoscopic depth.

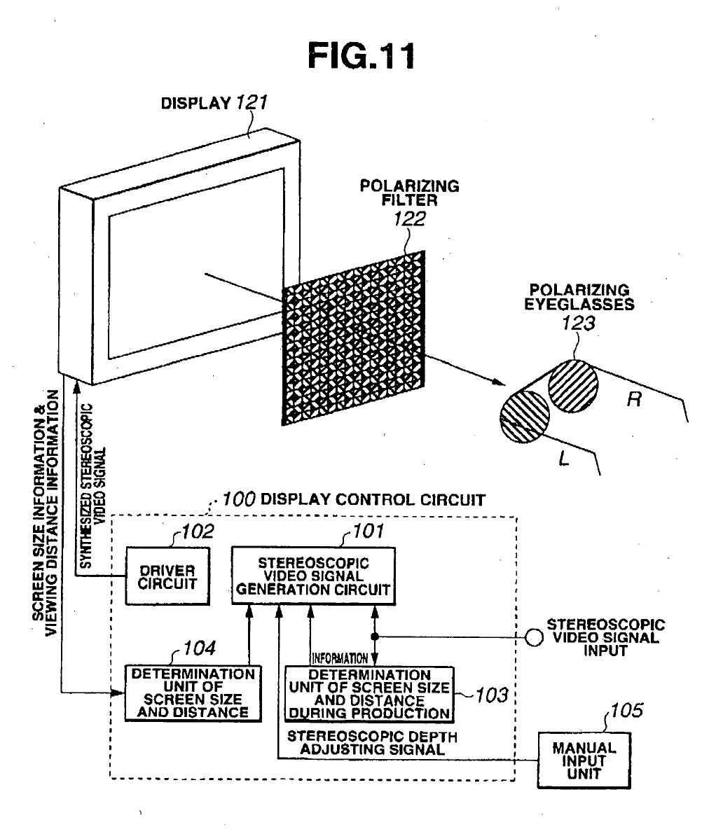

FIG. 11 shows a configuration of another 3D display using the stereoscopic video signal generation circuit according to a further embodiment of the present invention.

The display 121 has a plasma display panel in which the left-eye image and the right-eye image are displayed on alternate pixels arranged on each horizontal line. On the next horizontal line down, the right-eye image and the left-eye image are displayed on alternate pixels different in horizontal position from (or staggered in horizontal position from) those of the immediately preceding horizontal line. That is, the left-eye image is displayed on a check pattern of pixels of the plasma display panel and the right-eye image is displayed on the remaining pixels (arranged in a reverse check pattern). In front of the plasma display panel is disposed a polarizing filter 122 which has polarizing filter elements arranged in a matrix corresponding to that of the pixels of the plasma display panel.

The polarizing filter 122 has a first region that passes first rays of light with a particular polarization and a second region that passes second rays of light whose polarization axis is perpendicular to that of the first region, the first and second regions being arranged to face the corresponding pixels on the plasma display panel. That is, the polarizing filter 122 has the two regions, each of which transmits differently polarized light, arranged in a checkered pattern in units of single pixels of the plasma display panel. Thus, the left-eye image and the right-eye image that are displayed on alternate pixels of the plasma display panel are separated into differently polarized rays of light that are projected toward an observer. In this way, a left-eye image display region and a right-eye image display region are formed in a checkered pattern in units of single pixels.

The observer sees through the polarizing eyeglasses 123 a 3D image displayed on the display 121. The left- and right-eye lenses of the polarizing glasses have the same polarizations as those of the first and second regions of the polarizing filter 122. That is, the left-eye lens of the polarizing glasses transmits light that has passed through the first region of the polarizing filter 122 and the right-eye lens transmits light that has passed through the second region of the polarizing filter 122. Thus, the left-eye image displayed on the display 121 passes through the left-eye lens of the polarizing glasses and reaches the left eye of the observer while the right-eye image passes through the right-eye lens of the polarizing glasses and reaches the right eye.

A display control circuit 100 comprises a stereoscopic video signal generation circuit 101, a driver circuit 102, an in-production screen size & distance decision unit 103 and a screen size & distance decision unit 104. These circuits have the same functions as those in the previous embodiment (FIG. 5) and their detailed descriptions are omitted.

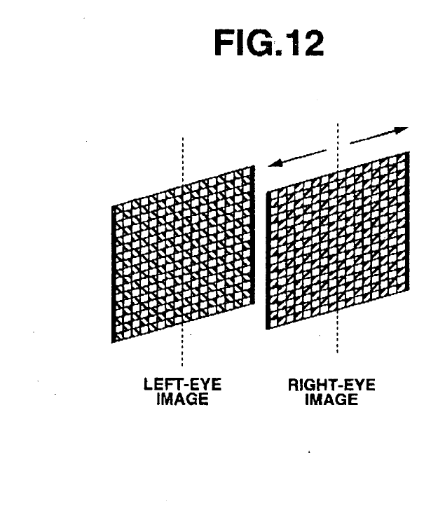

FIG. 12 is an explanatory diagram showing a relation between the left-eye image and the right-eye image formed on the display 121.

The left-eye image reaching the left eye of the observer and the right-eye image reaching the right eye are displayed on alternate pixels of the display 121. The stereoscopic video signal generation circuit 101 performs control to delay or advance the timing of reading the right-eye image from the right-eye image frame memory 31 to delay or advance a horizontal phase of the right-eye image with respect to the left-eye image and thereby change an offset of the right-eye image relative to the left-eye image to adjust a binocular parallax and therefore a stereoscopic depth.

In the display 121 explained in conjunction with the embodiments of FIG. 5 to FIG. 12, the display device may use an organic EL and a liquid crystal display panel instead of the plasma display panel. When a liquid crystal display panel is used as the display device, the polarizing filter 122 is replaced with a phase plate described later which consists of a first region with microfine phase plates and a second region with no microfine phase plates, the first and second regions being alternated repetitively, so that rays of light passing through these regions have different polarization axes.

Although the 3D displays described above use a polarizing filter system that separates differently polarized images into a left-eye image and a right-eye image by a polarizing filter, this invention can also be applied to 3D displays employing other image separation methods to form stereoscopic images. Examples of other image separation methods include a liquid crystal shutter method which separates by a liquid crystal shutter the left- and right-eye images that are displayed at different timings, and a color filter method which separates by color filters the left- and right-eye images that are displayed in different colors.

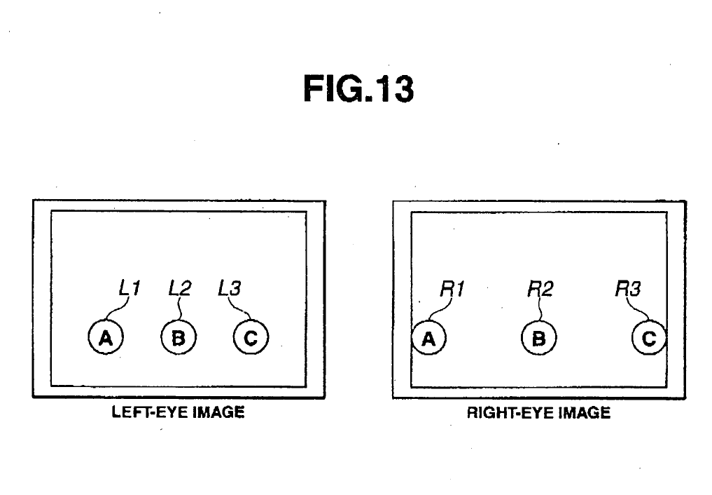

FIG. 13 to FIG. 15 show how a stereoscopic image is seen.

FIG. 13 explains how a left-eye image and a right-eye image show. On the screen three objects A, B, C are displayed. The object A displayed in the left-side area of the screen is shown more to the right in the left-eye image (L1) than in the right-eye image (R1). The object B displayed at the central part of the screen assumes the same position in both the left-eye image (L2) and the right-eye image (R2) (i.e., there is no binocular parallax). The object C displayed in the right-side area of the screen is shown more to the left in the left-eye image (L3) than in the right-eye image (R3).

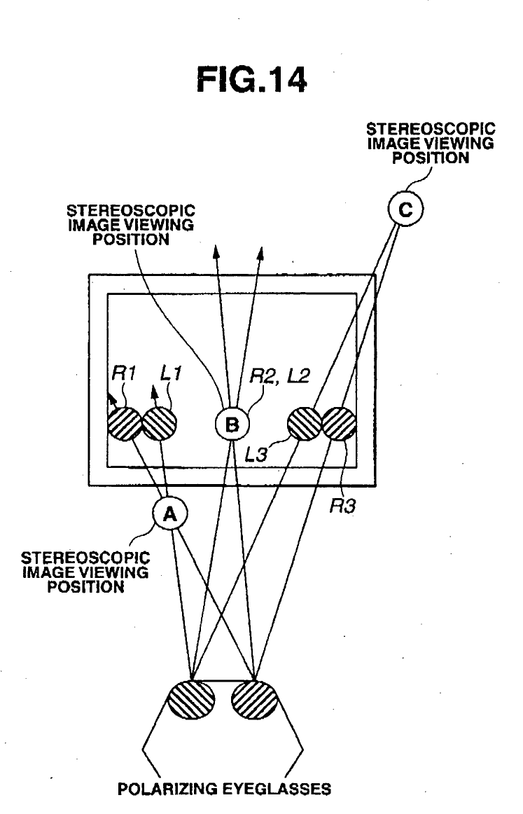

FIG. 14 shows where a stereoscopic image is formed by the left-eye image and the right-eye image of FIG. 13 is seen.

Since the object A displayed in the left-side area of the screen is shown more to the right in the left-eye image (L1) than in the right-eye image (R1), a line of sight from the left eye seeing the left-eye image and a line of sight from the right eye seeing the right-eye image intersect in front of the screen. Because a 3D image emerges at a crosspoint of the sight lines of the eyes, the 3D image of the object A is seen in front of the screen.

Since the object B displayed at the central part of the screen is shown at the same position in both the left-eye image (L2) and the right-eye image (R2), a sight line from the left eye viewing the left-eye image and a sight line from the right eye viewing the right-eye image intersect on the screen. Thus, the 3D image of the object B appears on the screen.

Since the object C displayed in the right-side area of the screen is shown more to the left in the left-eye image (L3) than in the right-eye image (R3), a sight line from the left eye viewing the left-eye image and a sight line from the right eye viewing the right-eye image intersect behind the screen. Thus, the 3D image of the object C appears on the far side of the screen.

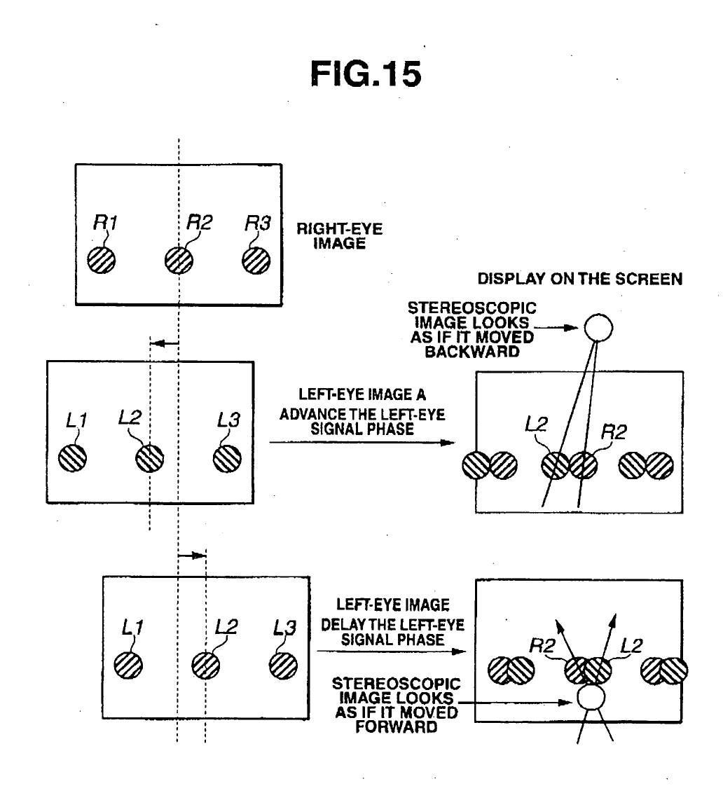

FIG. 15 shows where a stereoscopic image appears when the left-eye image of FIG. 13 is shifted.

If the timing of reading the right-eye image is delayed with respect to the left-eye image read timing (by advancing the phase of a left-eye signal) to offset the left-eye image to the left relative to the right-eye image as shown in the middle diagram, since the object B displayed at the central part of the screen is displayed more to the left in the left-eye image (L2) than in the right-eye image (R2), the sight line of the left eye seeing the left-eye image and the sight line of the right eye seeing the right-eye image intersect behind the screen. Thus, the 3D image of the object B appears on the far side of the screen.

If the timing of reading the right-eye image is advanced with respect to the left-eye image read timing (by delaying the phase of the left-eye signal) to offset the left-eye image to the right relative to the right-eye image as shown in the bottom diagram, since the object B displayed at the central part of the screen is displayed more to the right in the left-eye image (L2) than in the right-eye image (R2), the sight line of the left eye seeing the left-eye image and the sight line of the right eye seeing the right-eye image intersect in front of the screen. Thus, the 3D image of the object B appears on the near side of the screen.

As described above, the 3D display according to these embodiments of the present invention comprises a stereoscopic video signal generation circuit 101 that generates a stereoscopic video signal by combining the left-eye image and the right-eye image, a display 121 for displaying a stereoscopic image, and a driver circuit 102 for driving the display 121. The stereoscopic video signal generation circuit 101 uses the read timing controller 32 in constructing an information retrieving means for retrieving information on a display area of the display 121 (screen size information) and an offset setting means for offsetting the left-eye image and the right-eye image relative to each other based on the display area information to adjust the three-dimensional effect of an image formed on the display 121. The driver circuit 102 displays a stereoscopic image on the display 121 according to a stereoscopic video signal output from the stereoscopic video signal generation circuit 101. Thus, it is possible to produce a stereoscopic image whose stereoscopic depth is optimumly adjusted according to the screen size of the display 121.

Further, the 3D display according to the embodiments of the present invention has a memory means for storing a screen size as information on the display area of the display 121, and the information retrieving means (read timing controller 32) of the stereoscopic video signal generation circuit 101 retrieves the screen size information from the memory means. Therefore, if the display 121 is replaced, a 3D image with an optimum stereoscopic depth corresponding to the screen size of the new display 121 can be produced.

The information retrieving means (read timing controller 32) of the stereoscopic video signal generation circuit 101 also retrieves CP information (information on a distance to the crosspoint of the optical axes of the left- and right-eye image cameras, recorded along with the 3D image), and the offset setting means (read timing controller 32) sets an offset of the left-eye image and the right-eye image relative to each other based on the crosspoint information retrieved to adjust the stereoscopic depth of the 3D image formed on the display 121. It is thus possible to produce a 3D image whose stereoscopic depth is optimumly adjusted for the screen size based on the crosspoint information recorded along with the 3D image.

Further, an input unit 105 is provided for an observer to enter information on the three-dimensional effect and the screen size, and the offset setting means (read timing controller 32) offsets the left-eye image and the right-eye image according to the information entered into the input unit 105 to adjust the stereoscopic depth of a 3D image formed on the display 121. Therefore, if there are variations among individuals in the interocular distance and the three-dimensional sensation, it is possible to finely adjust the stereoscopic depth according to the observer's preference and thereby produce a 3D image most suited to the observer.

That is, there are variations among individuals in stereoscopic sensation (depth) obtained when viewing a 3D image and it is difficult for a 3D video content already set with a particular stereoscopic depth by the content producer to meet requirements of all observers. The stereoscopic depth is often expressed as a viewing effect more emphasized than resolution, color and brightness of conventional two-dimensional (2D) video. Hence, the stereoscopic video signal generation circuit 101 of this invention uses the distance between the left- and right-eye cameras and the crosspoint (or the crosspoint and the interocular distance during the CG production) recorded together with the 3D image—the factors which determine the stereoscopic depth—to automatically adjust the stereoscopic depth according to the screen size of the 3D display. Further, to deal with individual variations, the stereoscopic video signal generation circuit 101 has a manual fine adjust function, allowing the stereoscopic depth to be optimumly adjusted according to a preference of any observer and any screen size of the display. Therefore, if the same 3D video content is seen on a variety of screen sizes, it can be viewed with a natural stereoscopic depth without changing the 3D content. Further, since a 3D video content can be enjoyed not only with dedicated facilities or equipment but also with any other 3D displays of various screen sizes, this invention enables sale, broadcasting and distribution of 3D video software to a wide range of consumers using unspecified sizes of displays.

The stereoscopic video signal generation circuit 101 according to the embodiments of the present invention has the left-eye image frame memory 30 for storing a left-eye image and the right-eye image frame memory 31 for storing a right-eye image. The offset setting means (read timing controller 32) has in the read timing controller 32 a timing control means which generates a timing signal for controlling the timing at which to read video data from the left-eye image frame memory 30 and/or right-eye image frame memory 31. The timing control means (read timing controller 32) offsets the left-eye image and the right-eye image relative to each other by advancing or delaying the timing of reading the video data from at least one of the left- and right-eye image frame memories 30, 31 with respect to the timing of reading the video data from the other frame memory. Because of this arrangement, the offset of the left- and right-eye images can be set with a simple circuit.

The stereoscopic video signal generation circuit 101 has the synthesized frame memory 50 for storing a 3D image and the signal selector 40 for selecting between the image data read out from the left-eye image frame memory 30 and the image data read out from the right-eye image frame memory 31 and for feeding the selected image data to the synthesized frame memory 50. This allows the offset left- and right-eye images to be combined and stored in the synthesized frame memory 50.

Next, a method of calculating of the offset of the left- and right-eye images will be explained.

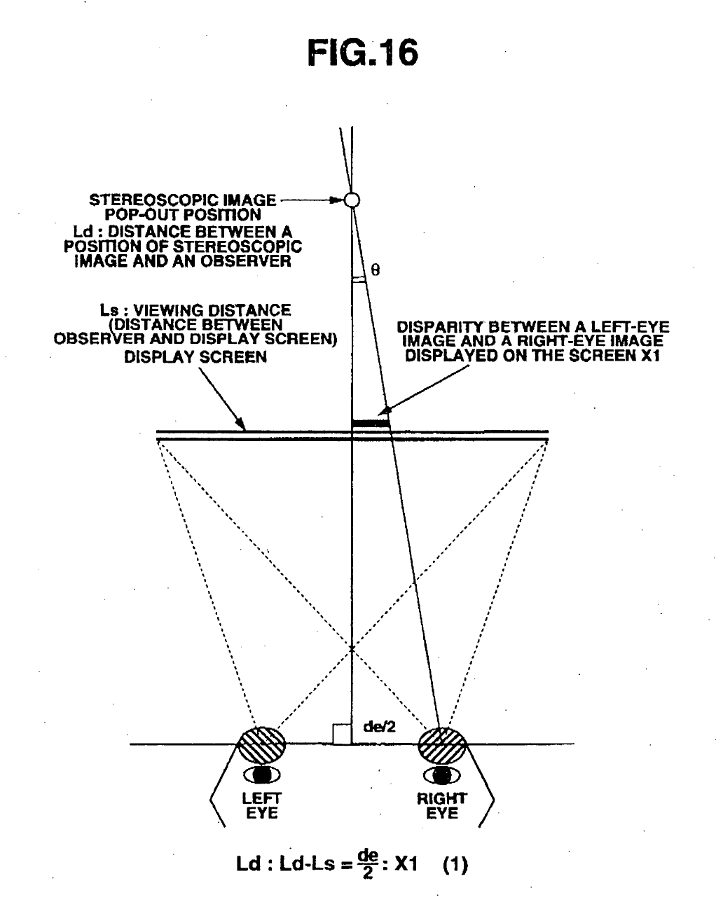

FIG. 16 shows a relation between a parallax of the original 3D image and a position where the 3D image emerges. In the original 3D image 300, as shown in FIG. 2, the right-eye image and the left-eye image assume the same positions as when they were shot. Let a position where a 3D image emerges (distance between the 3D image position and the observer) be Ld, a viewing distance (distance between the observer and the screen) be Ls, a parallax or parallax between the left-eye image and the right-eye image displayed on the screen be X1, and an interocular distance be de (about 65 mm). These parameters can be expressed by equation (1) shown in FIG. 16. By solving this equation, the 3D emerging position Ld can be determined as a function of the parallax X1. X1 changes in proportion with the size of the screen.

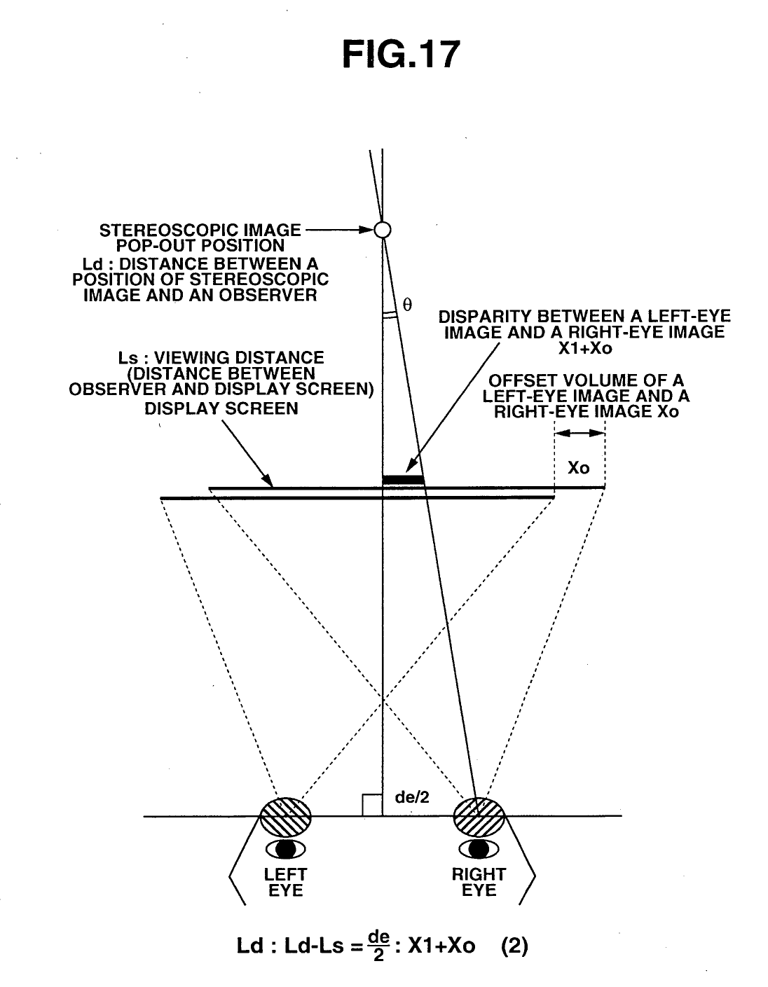

FIG. 17 shows a relation between a parallax between the left- and right-eye images and a position where the 3D image emerges when the left- and right-eye images are offset. Let a position where a 3D image emerges (distance between the 3D image position and the observer) be Ld, a viewing distance (distance between the observer and the screen) be Ls, an offset between the left- and right-eye images be Xo, a parallax or parallax between the left-eye image and the right-eye image displayed on the screen be X1, and an interocular distance be de (about 65 mm). These parameters can be expressed by equation (2) shown in FIG. 17. To produce the 3D image at the same position Ld as the original 3D image, the Ld determined by equation (1) of FIG. 16 is substituted in equation (2) to determine the offset between the left- and right-eye images Xo.

The 3D display described above can be applied to a variety of devices, such as cell phones, 3D TV sets and 3D projectors. It is also applicable to three-dimensional movie theaters, video reproducing equipment that reproduce 3D videos distributed via Internet, three-dimensional game machines, and to aircraft and car simulators.

### INDUSTRIAL APPLICABILITY

According to a first aspect of this invention, there is provided a stereoscopic video signal generation circuit for supplying a stereoscopic video signal to a three-dimensional display, wherein the three-dimensional display, displaying two images in the left eye and the right eye with binocular parallax and then selectively retrieving one of the two images in one of the left eye and the right eye and other in other of both eyes, forms a stereoscopic image to show an observer by taking advantage of binocular parallax, the stereoscopic video signal generation circuit comprising: an information retrieving means for retrieving as control information for controlling a display of each image video information including crosspoint (convergence point) information on a distance from a camera to a crosspoint of an optical axis of a left subject and an optical axis of a right subject when each of left image and right image is produced; and an offset setting means for offsetting a left-eye image and a right-eye image relative to each other according to the control information to adjust a stereoscopic depth of the image displayed.

According to the invention, since the right-eye image and the left-eye image can be shifted according to the crosspoint (convergence point) information of the stereoscopic image produced, the arrangement can produce a stereoscopic image with its stereoscopic depth optimally adjusted for the three-dimensional display according to a production condition and an observation condition of the stereoscopic image.

According to a second aspect of this invention, there is provided a stereoscopic video signal generation circuit according to the first aspect, wherein the above information retrieving means retrieves as the video information at least one of information, comprising: applicable screen size information as video information suited for reproducing the stereoscopic image; applicable viewing distance information as display information on a distance from an observer to a screen suited for the observer to see the image as it is reproduced; and display information as video information involving viewing distance information on a distance from the observer to the screen of the three-dimensional display, wherein the offset setting means offsets the left-eye image and the right-eye image relative to each other according to one or more of the optimal screen size information and the applicable viewing distance information to adjust the stereoscopic depth of the image displayed.

According to the invention, since the information retrieving means is fixed according to applicable screen size information on a screen size applicable for reproducing a stereoscopic image, applicable viewing distance information, size information of the three-dimensional display and a distance from the observer to the display, it is possible to produce a stereoscopic image with its stereoscopic depth optimally adjusted for the screen size of the three-dimensional display. In particular, if the three-dimensional effect is reproduced based on the screen size information, a stereoscopic image produced has an optimally adjusted stereoscopic depth even if the screen size of the three-dimensional display changes. Further, if the three-dimensional effect is reproduced based on the applicable viewing distance information and the viewing distance information, a stereoscopic image produced has an optimally adjusted stereoscopic depth even when the position of the observer relative to the three-dimensional display (distance between the observer and the three-dimensional display) changes.

According to a third aspect of this invention, there is provided a stereoscopic video signal generation circuit according to one of the first and second aspects, wherein the information retrieving means retrieves as video information information on a distance between an optical axis of a left-eye camera and an optical axis of a right-eye camera, wherein the offset setting means offsets the left-eye image and the right-eye image relative to each other according to the camera distance information and the crosspoint (convergence point) information to adjust the stereoscopic depth of the image displayed.

According to the invention, a stereoscopic image can be obtained which is adjusted to the optimal depth of a stereoscopic image according to the screen size of the stereoscopic display by the distance between cameras set relative to the stereoscopic image.

According to a fourth aspect of this invention, there is provided a stereoscopic video signal generation circuit according to any one of the first to third aspects, wherein the information input means retrieves information entered about the stereoscopic depth and the offset setting means offsets the left-eye image and the right-eye image relative to each other according to the information entered into the input means to adjust the stereoscopic depth of the image displayed.

According to the invention, it is therefore possible to produce a stereoscopic image whose stereoscopic depth is adjusted according to the observer's preference.

According to a fifth aspect of this invention, there is provided a stereoscopic video signal generation circuit according to any one of the first to fourth aspects, wherein a left-eye image frame memory for storing the left-eye image and a right-eye image frame memory for storing the right-eye image are provided; the offset setting means has a timing control means for controlling a timing of reading video data from the left-eye image frame memory and/or the right-eye image frame memory; and the timing control means advances or delays the timing of reading the video data from one of the left-eye image frame memory and the right-eye image frame memory with respect to the timing of reading the video data from the other frame memory to offset the left-eye image and the right-eye image relative to each other.

According to the invention, the offset of the left- and right-eye images can, therefore, be set with a simple circuit.

According to a sixth aspect of this invention, there is provided a stereoscopic video signal generation circuit according to the fifth aspect, wherein, since stereoscopic video signal generation circuit has a stereoscopic image frame memory for storing the stereoscopic image and a signal selection means for selecting between video data read out from the left-eye image frame memory and video data read out from the right-eye image frame memory and feeding the selected data into the stereoscopic image frame memory, it is possible to synthesize the offset left- and right-eye images and store the synthesized image in the frame memory.

According to a seventh aspect of this invention, there is provided a stereoscopic video signal generation circuit according to any one of the first to fourth aspects, wherein, the left-eye image and the right-eye image are offset relative to each other by advancing or delaying a horizontal phase between the left-eye image and the right-eye image. According to the invention, since the left- and right-eye images are shifted from their original positions on the display, the offset of the left- and right-eye images can be controlled easily.

According to an eighth aspect of this invention, there is provided a stereoscopic video signal generation circuit according to any one of the first to seventh aspects, wherein when the left-eye image and the right-eye image are-offset, in left and/or right end blanked-out areas of the screen where information of the left-eye image and/or the right-eye image is not displayed, left or right edge portion of the left-eye image and/or the right-eye image near the blanked-out areas is displayed magnified horizontally and vertically.

According to the invention, the left and/or right end areas of the screen where video information is not supplied can be prevented from being displayed in black. This in turn prevents an observer from feeling incongruous with the otherwise abnormal display of an image.

According to a ninth aspect of this invention, there is provided a three-dimensional display which displays two images of a left image and a right image formed with binocular parallax and selectively retrieves one of the two images in one of the left eye and the right eye and other in other of both eyes for forming a stereoscopic image to show an observer by taking advantage of parallax, the three-dimensional display comprising: a stereoscopic video signal generation circuit for combining a left-eye image and a right-eye image to generate a stereoscopic video signal, a display for displaying the stereoscopic image and a driver circuit for driving the display; wherein the stereoscopic video signal generation circuit has an information retrieving means for retrieving as control information for controlling a display of each image video information including crosspoint (convergence point) information on a distance from a camera to a crosspoint of an optical axis of the left subject and an optical axis of the right subject at a time when each of left image and right image is produced, and an offset setting means for offsetting the left-eye image and the right-eye image relative to each other according to the control information to adjust a stereoscopic depth of the image displayed on the display; wherein the driver circuit forms the stereoscopic image on the display according to the stereoscopic video signal output from the stereoscopic video signal generation circuit.

According to the invention, a stereoscopic image produced has a stereoscopic depth optimally adjusted for the screen size of the display.

According to a tenth aspect of this invention, there is provided a three-dimensional display according to the ninth aspect, further comprising: a memory means for storing as the video information at least one of applicable screen size information as video information suited for reproducing the stereoscopic image, applicable viewing distance information on a distance from an observer to a screen suited for the observer to see the image as it is reproduced, and display information involving the applicable viewing distance information relative to the screen of the three-dimensional display, wherein the offset setting means offsets the left-eye image and the right-eye image relative to each other according to the information which the memory means stores for reproducing the stereoscopic depth of the image displayed.

According to the invention, this arrangement allows the stereoscopic depth of a stereoscopic image to be optimally adjusted for the screen size even if the display is replaced.

According to an eleventh aspect of this invention, there is provided a three-dimensional display according to one of the ninth and tenth aspects, wherein the information retrieving means retrieves as the video information distance information on a distance between an optical axis of a left-eye camera and an optical axis of a right-eye camera; and the offset setting means offsets the left-eye image and the right-eye image relative to each other according to the camera distance information and the crosspoint (convergence point) information to adjust the stereoscopic depth of the image displayed on the display. According to the invention, the stereoscopic image produced has a stereoscopic depth optimally adjusted based on the information on the production of stereoscopic image even if the screen size of the three-dimensional display or the viewing distance of the observer changes.

According to a twelfth aspect of this invention, there is provided a three-dimensional display according to any one of the ninth to eleventh aspects, further comprising: an input means for the observer to input information on the stereoscopic depth; wherein the offset setting means offsets the left-eye image and the right-eye image relative to each other according to the information entered into the input means.

According to the invention, it is possible to produce a stereoscopic image whose stereoscopic depth is optimally adjusted according to the observer's preference.

According to a thirteenth aspect of this invention, there is provided a three-dimensional display according to any one of the ninth to twelfth aspects, further comprising: a left-eye image frame memory for storing the left-eye image and a right-eye image frame memory for storing the right-eye image; wherein the offset setting means has a timing control means for controlling a timing of reading video data from the left-eye image frame memory and/or the right-eye image frame memory, and the timing control means advances or delays the timing of reading the video data from one of the left-eye image frame memory and the right-eye image frame memory with respect to the timing of reading the video data from the other frame memory to offset the left-eye image and the right-eye image relative to each other.

According to the invention, this arrangement allows the offset of the left- and right-eye images to be set with a simple circuit.

According to a fourteenth aspect of this invention, there is provided a three-dimensional display according to any one of the ninth to thirteenth aspects, further comprising: a stereoscopic image frame memory for storing the stereoscopic image; and a signal selection means for selecting between left-eye image data read out from the left-eye image frame memory and right-eye image data read out from the right-eye image frame memory and feeding the selected data into the stereoscopic image frame memory.

According to the invention, it is possible to synthesize the offset left- and right-eye images and store the synthesized image in the frame memory.

According to a fifteenth aspect of this invention, there is provided a three-dimensional display according to any one of the ninth to fourteenth aspects, wherein the left-eye image and the right-eye image are offset relative to each other by advancing or delaying a horizontal phase between the left-eye image and the right-eye image.

According to the invention, the arrangement allows the left-eye image and the right-eye image to be displayed at a different timing to control easily the offsetting of the left-eye image and the right-eye image.

According to a sixteenth aspect of this invention, there is provided a three-dimensional display according to any one of the ninth to fifteenth aspects, wherein, when the left-eye image and the right-eye image are offset, in left and/or right end blanked-out areas of the screen where information of the left-eye image and/or the right-eye image is not displayed, left or right edge portion of the left-eye image and/or the right-eye image near the blanked-out portions is displayed magnified horizontally and vertically.

1. A stereoscopic video signal generation circuit for supplying a stereoscopic video signal to a three-dimensional display, wherein the three-dimensional display, displaying two images in the left eye and the right eye with binocular parallax and then selectively retrieving one of the two images in one of the left eye and the right eve and other in other of both eyes, forms a stereoscopic image to show an observer by taking advantage of binocular parallax, the stereoscopic video signal generation circuit comprising:
an information retrieving means for retrieving as control information for controlling a display of each image video information including crosspoint (convergence point) information on a distance from a camera to a crosspoint of an optical axis of a left subject and an optical axis of a right subject when each of left image and right image is produced; and
an offset setting means for offsetting a left-eye image and a right-eye image relative to each other according to the control information to adjust a stereoscopic depth of the image displayed.

2. A stereoscopic video signal generation circuit according to claim 1, wherein the information retrieving means retrieves as the video information at least one of information comprising:
applicable screen size information as video information suited for reproducing the stereoscopic image;
applicable viewing distance information as the display information on a distance from an observer to a screen suited for the observer to see the image as it is reproduced,; and
display information as the video information involving viewing distance information on a distance from the observer to the screen of the three-dimensional display,
wherein the offset setting means offsets the left-eye image and the right-eye image relative to each other according to one or more of the optimal screen size information and the applicable viewing distance information to adjust the stereoscopic depth of the image displayed.

3. A stereoscopic video signal generation circuit according to claim 2, wherein the information retrieving means retrieves as the video information information on a distance between an optical axis of a left-eye camera and an optical axis of a right-eye camera,
wherein the offset setting means offsets the left-eye image and the right-eye image relative to each other according to the camera distance information and the crosspoint (convergence point) information to adjust the stereoscopic depth of the image displayed.

4. A stereoscopic video signal generation circuit according to claim 1, wherein the information input means retrieves information entered about the stereoscopic depth and the offset setting means offsets the left-eye image and the right-eye image relative to each other according to the information entered into the input means to adjust the stereoscopic depth of the image displayed.

5. A stereoscopic video signal generation circuit according to claim 1, further comprising:
a left-eye image frame memory for storing the left-eye image and a right-eye image frame memory for storing the right-eye image;
wherein the offset setting means has a timing control means for controlling a timing of reading video data from the left-eye image frame memory and/or the right-eye image frame memory, and the timing control means advances or delays the timing of reading the video data from one of the left-eye image frame memory and the right-eye image frame memory with respect to the timing of reading the video data from the other frame memory to offset the left-eye image and the right-eye image relative to each other.

6. A stereoscopic video signal generation circuit according to claim 5, further comprising:
a stereoscopic image frame memory for storing the stereoscopic image; and
a signal selection means for selecting between video data read out from the left-eye image frame memory and video data read out from the right-eye image frame memory and feeding the selected data into the stereoscopic image frame memory.

7. A stereoscopic video signal generation circuit according to claim 1, wherein the left-eye image and the right-eye image are offset relative to each other by advancing or delaying a horizontal phase between the left-eye image and the right-eye image.

8. A stereoscopic video signal generation circuit according to claim 1, wherein, when the left-eye image and the right-eye image are offset, in left and/or right end blanked-out areas of the screen where information of the left-eye image and/or the right-eye image is not displayed, left or right edge portion of the left-eye image and/or the right-eye image near the blanked-out areas is displayed magnified horizontally and vertically.

9. A three-dimensional display which displays two images of a left image and a right image formed with binocular parallax and selectively retrieves one of the two images in one of the left eye and the right eye and other in other of both eyes for forming a stereoscopic image to show an observer by taking advantage of parallax, the three-dimensional display comprising: a stereoscopic video signal generation circuit for combining a left-eye image and a right-eye image to generate a stereoscopic video signal, a display for displaying the stereoscopic image and a driver circuit for driving the display;
wherein the stereoscopic video signal generation circuit has
an information retrieving means for retrieving as control information for controlling a display of each image video information including crosspoint (convergence point) information on a distance from a camera to a crosspoint of an optical axis of the left subject and an optical axis of the right subject when each of left image and right image is produced, and
an offset setting means for offsetting the left-eye image and the right-eye image relative to each other according to the control information to adjust a stereoscopic depth of the image displayed on the display;
wherein the driver circuit forms the stereoscopic image on the display according to the stereoscopic video signal output from the stereoscopic video signal generation circuit.

10. A three-dimensional display according to claim 9, further comprising: a memory means for storing
as the video information at least one of applicable screen size information as video information suited for reproducing the stereoscopic image, applicable viewing distance information on a distance from an observer to a screen suited for the observer to see the image as it is reproduced and display information involving the applicable viewing distance information relative to the screen of the three-dimensional display,
wherein the offset setting means offsets the left-eye image and the right-eye image relative to each other according to the information which the memory means stores for reproducing the stereoscopic depth of the image displayed.

11. A three-dimensional display according to claim 9, wherein the information retrieving means retrieves as the video information distance information on a distance between an optical axis of a left-eye camera and an optical axis of a right-eye camera,
wherein the offset setting means offsets the left-eye image and the right-eye image relative to each other according to the camera distance information and the crosspoint (convergence point) information to adjust the stereoscopic depth of the image displayed.

12. A three-dimensional display according to claim 9, wherein an input means for the observer to input information on the stereoscopic depth;
wherein the offset setting means offsets the right-eye image and the left-eye image relative to each other according to the information entered into the input means.

13. A three-dimensional display according to claim 9, further comprising:
a left-eye image frame memory for storing the left-eye image and a right-eye image frame memory for storing the right-eye image,
wherein the offset setting means has a timing control means for controlling a timing of reading video data from the left-eye image frame memory and/or the right-eye image frame memory, and the timing control means advances or delays the timing of reading the video data from one of the left-eye image frame memory and the right-eye image frame memory with respect to the timing of reading the video data from the other frame memory to offset the left-eye image and the right-eye image relative to each other.

14. A three-dimensional display according to claim 9, further comprising:
a stereoscopic image frame memory for storing the stereoscopic image; and
a signal selection means for selecting between right-eye image data read out from the right-eye image frame memory and left-eye image data read out from the left-eye image frame memory and feeding the selected data into the stereoscopic image frame memory.

15. A three-dimensional display according to claim 9,
wherein the right-eye image and the left-eye image are offset relative to each other by advancing or delaying a horizontal phase between the right-eye image and the left-eye image.

16. A three-dimensional display according to claim 9, wherein, when the right-eye image and the left-eye image are offset, in right and/or left end blanked-out areas of the screen where information of the right-eye image and/or the left-eye image is not displayed, right or left edge portion of the right-eye image and/or the left-eye image near the blanked-out portions is displayed magnified horizontally and vertically.

17. (canceled)
